(19) United States
(12) Patent Application Publication
(10) Pub. No.: US 2025/0219314 A1
(43) Pub. Date: Jul. 3, 2025

(54) Connector and Connector Assembly

(71) Applicant: Tyco Electronics (Shanghai) Co., Ltd., Shanghai (CN)

(72) Inventors: Wei Zhang, Shanghai (CN); Ming Shi, Shanghai (CN); Xiaozhi (George) Fu, Shanghai (CN); Zhao Cheng, Shanghai (CN); Dingbing (Frank) Fan, Shanghai (CN)

(73) Assignee: Tyco Electronics (Shanghai) Co., Ltd., Shanghai (CN)

(21) Appl. No.: 19/007,707

(22) Filed: Jan. 2, 2025

(30) Foreign Application Priority Data
Jan. 3, 2024 (CN) 202420014382.2

(51) Int. Cl. H01R 13/436; H01R 12/77; H01R 13/426; H01R 13/52; H01R 13/627

(52) U.S. Cl. CPC H01R 13/4361; H01R 12/774; H01R 13/426; H01R 13/521; H01R 13/5219; H01R 13/6272

(57) ABSTRACT

A connector includes a housing having an inner cavity, a flexible circuit board inserted into the inner cavity of the housing, and a sealing element fitted on the flexible circuit board. The sealing element is inserted into the housing and compressed between the housing and the flexible circuit board to seal between the housing and the flexible circuit board.

### CROSS-REFERENCE TO RELATED APPLICATION

This application claims the benefit of the filing date under 35 U.S.C. § 119 (a)-(d) of Chinese Patent Application No. 202420014382.2, filed on Jan. 3, 2024.

### FIELD OF THE INVENTION

The present invention relates to a connector and a connector assembly comprising the connector.

### BACKGROUND

Sealing a connector with a flexible printed circuit (FPC) is difficult. The FPC is thin, wide, and flexible, which makes it difficult to use a traditional sealing ring to achieve sealing between the FPC and a connector housing. Most connectors with flexible circuit boards on the market currently do not meet sealing requirements, which limits the scope of use of such connectors.

### SUMMARY

A connector includes a housing having an inner cavity, a flexible circuit board inserted into the inner cavity of the housing, and a sealing element fitted on the flexible circuit board. The sealing element is inserted into the housing and compressed between the housing and the flexible circuit board to seal between the housing and the flexible circuit board.

### BRIEF DESCRIPTION OF THE DRAWINGS

Features of the present invention will become more apparent by describing in detail exemplary embodiments thereof with reference to the accompanying drawings, in which:

FIG. 1 shows an illustrative perspective view of a connector assembly according to an exemplary embodiment of the present invention, wherein the connector and the mating connector are mated;

FIG. 2 shows an illustrative exploded view of a connector assembly according to an exemplary embodiment of the present invention;

FIG. 3 shows a longitudinal sectional view of the connector and mating connector shown in FIG. 2;

FIG. 4 shows a longitudinal sectional view of the connector and mating connector shown in FIG. 1;

FIG. 5 shows an illustrative exploded view of a connector according to an exemplary embodiment of the present invention;

FIG. 6 shows an illustrative perspective view of a connector according to an exemplary embodiment of the present invention when viewed from the rear side;

FIG. 7 shows an illustrative assembly view of a flexible circuit board and a sealing element of a connector according to an exemplary embodiment of the present invention;

FIG. 8 shows a cross-sectional view of the flexible circuit board and seal shown in FIG. 7;

FIG. 9 shows an illustrative sectional, exploded view of a flexible circuit board and seal of a connector according to an exemplary embodiment of the present invention;

FIG. 10 shows an illustrative exploded view of a mating connector according to an exemplary embodiment of the present invention;

FIG. 11 shows an illustrative exploded view of a mating connector according to an exemplary embodiment of the present invention when viewed from the front side;

FIG. 12 shows a longitudinal sectional view of a connector according to another exemplary embodiment of the present invention;

FIG. 13 shows an illustrative sectional, exploded view of a connector according to another exemplary embodiment of the present invention; and

FIG. 14 shows an illustrative sectional, exploded view of a flexible circuit board and seal of a connector according to another exemplary embodiment of the present invention.

### DETAILED DESCRIPTION

Exemplary embodiments of the present disclosure will be described hereinafter in detail with reference to the attached drawings, wherein like reference numerals refer to like elements. The present disclosure may, however, be embodied in many different forms and should not be construed as being limited to the embodiments set forth herein; rather, these embodiments are provided so that the present disclosure will convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

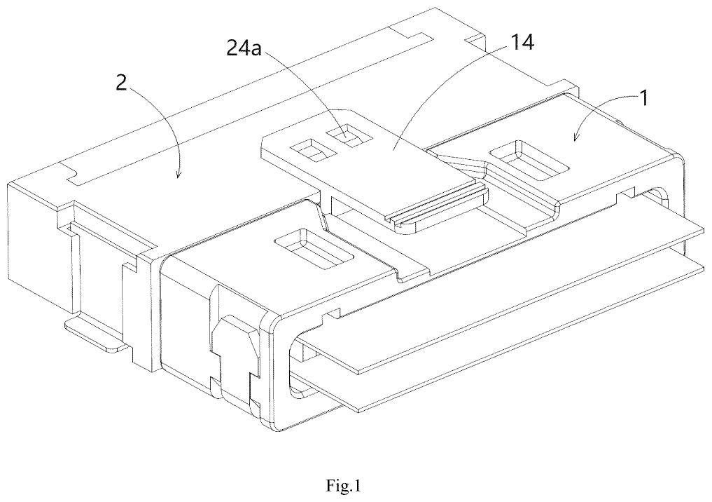

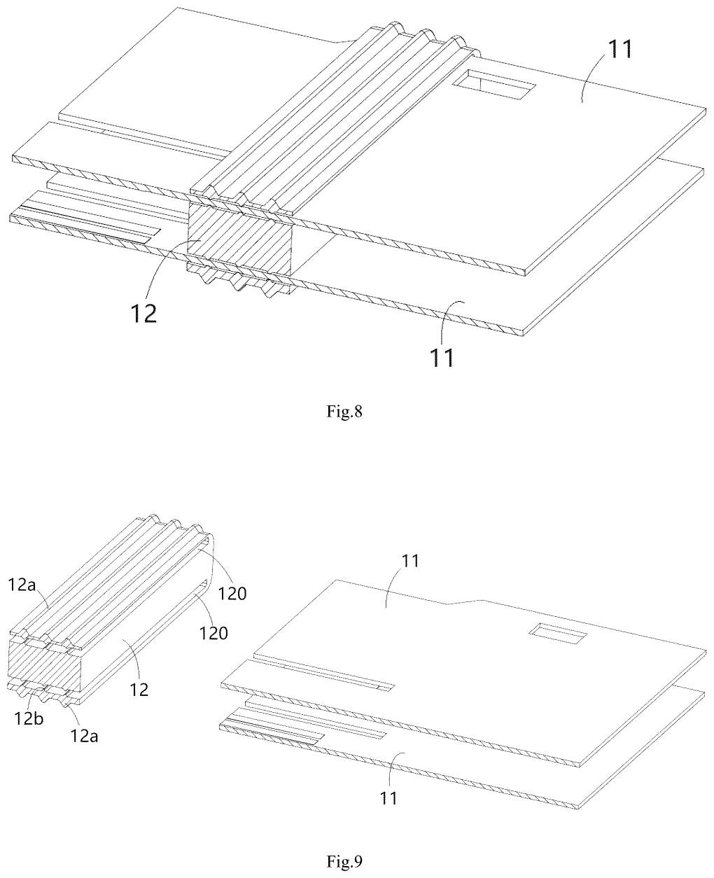

As shown in FIGS. 1 to 6, in an exemplary embodiment of the present invention, a connector 1 is disclosed. The connector 1 includes a housing 10, a flexible circuit board 11, and a sealing element 12. An inner cavity 101 is formed in the housing 10, as shown in FIG. 5. The flexible circuit board 11 is inserted into the inner cavity 101 of the housing 10. The sealing element 12 is fitted onto the flexible circuit board 11, as shown in FIGS. 5 and 7-9. The sealing element 12 is inserted into the inner cavity 101 of the housing 10 and compressed between the inner wall surface of the housing 10 and the flexible circuit board 11 to achieve sealing between the two.

As shown in FIG. 9, in the illustrated embodiment, a slit 120 is formed in the scaling element 12 to cooperate with the flexible circuit board 11, and the flexible circuit board 11 passes through the slit 120. An annular outer sealing rib 12a is formed on the outer peripheral surface of the sealing element 12, which contacts the inner wall surface of the housing 10 to achieve sealing between the two. An annular inner sealing rib 12b is formed on the inner peripheral surface of the slit 120 of the sealing element 12, which contacts the outer surface of the flexible circuit board 11 to achieve sealing between the two.

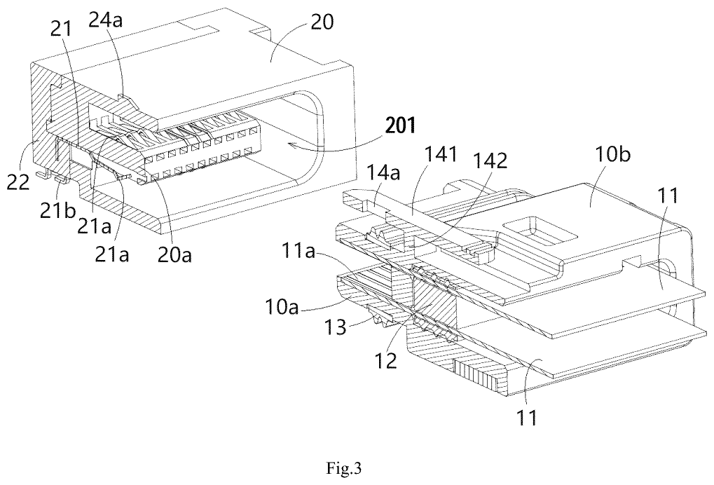

As shown in FIGS. 3 and 5, in the illustrated embodiment, the housing 10 has a front housing part 10a and a rear housing part 10b that are opposite in its longitudinal direction Y. The flexible circuit board 11 has a gold finger 11a formed on its front end portion, shown in FIG. 3, which is located in the front housing part 10a for electrical contact with the terminal 21 of the mating connector 2 inserted into the front housing part 10a.

As shown in FIG. 5, in the illustrated embodiment, the inner cavity 101 of the housing 10 has front and rear ports that are opposite in the longitudinal direction Y. The flexible circuit board 11 and the sealing element 12 are inserted into the housing 10 from the rear port of the inner cavity 101. The sealing element 12 is located in the rear housing part 10b to prevent moisture and dust from entering the front housing part 10a from the rear housing part 10b.

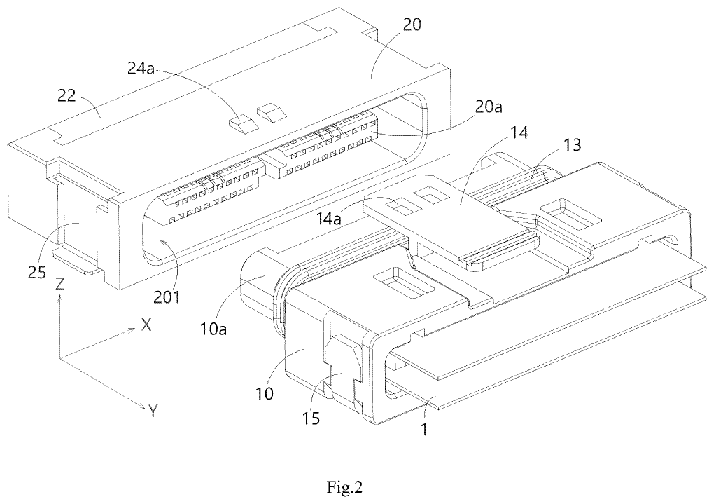

As shown in FIG. 2, in the illustrated embodiment, the connector 1 further comprises a sealing ring 13, which is fitted onto the front housing part 10a. The front housing part 10a is suitable for insertion into the mating housing 20 of the mating connector 2, and the sealing ring 13 is suitable for being compressed between the front housing part 10a and the inner wall surface of the mating housing 20 to achieve sealing between the two.

As shown in FIG. 5, in the illustrated embodiment, a sealing ring installation groove 103 is formed on the front housing part 10a, and the sealing ring 13 is installed in the sealing ring installation groove 103 of the front housing part 10a.

As shown in FIGS. 5, in the illustrated embodiment, the connector 1 further comprises a locking member 15, which is mounted on the rear housing part 10b for locking the flexible circuit board 11 in the housing 10.

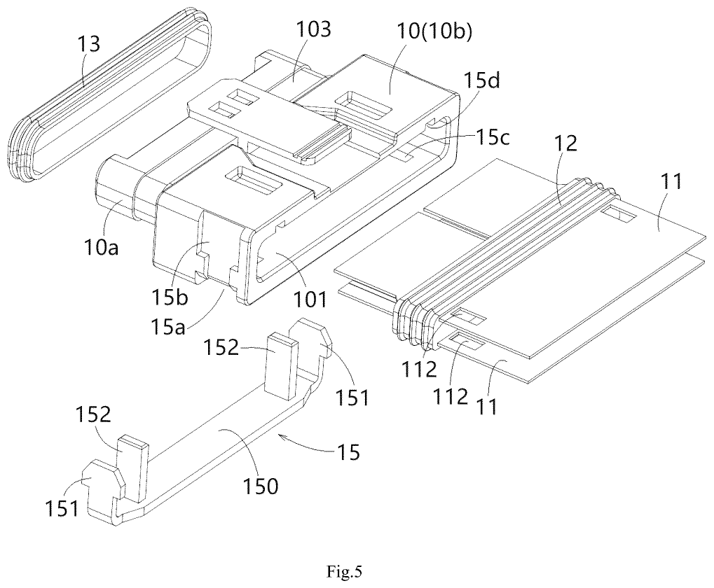

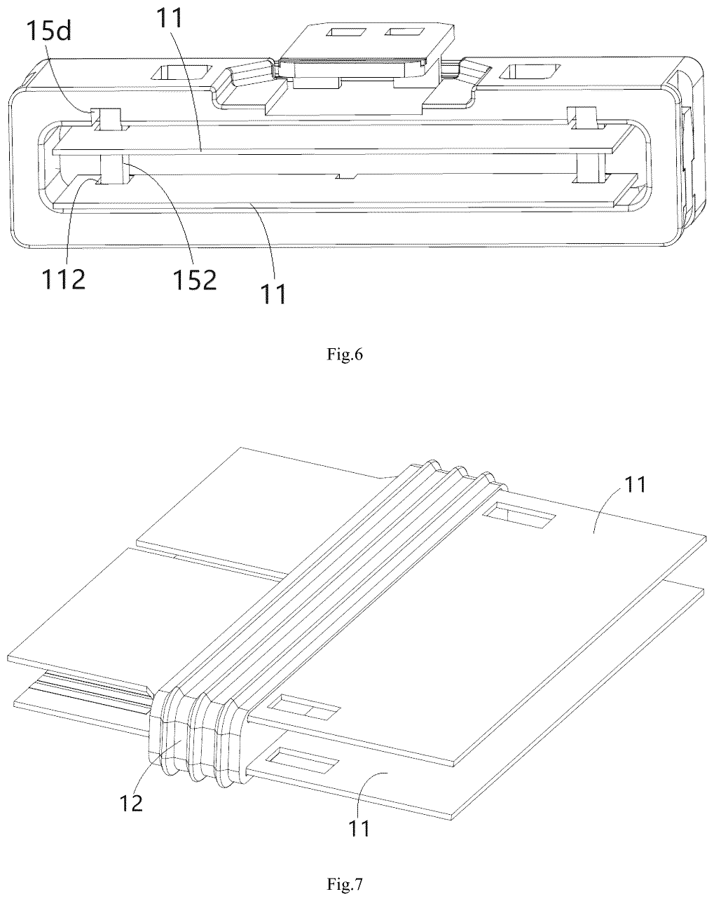

As shown in FIG. 5, in the illustrated embodiment, the locking member 15 includes an installation plate 150 and a locking tongue 152. The installation plate 150 is installed on the outer side of the rear housing part 10b. The locking tongue 152 is connected to the installation plate 150. An insertion hole 15c is formed in the bottom wall of the rear housing part 10b, and a slot hole 112 corresponding to the insertion hole 15c is formed in the flexible circuit board 11. The locking tongue 152 passes through the insertion hole 15c and the slot hole 112 along the height direction Z of the housing 10 to lock the flexible circuit board 11, as shown in FIG. 6.

As shown in FIG. 6, in the illustrated embodiment, a slot 15d is formed on the inner side of the top wall of the rear housing part 10b, and the end of the locking tongue 152 is engaged into the slot 15d.

As shown in FIGS. 2 and 5, in the illustrated embodiment, an installation slot 15a extending along the transverse direction X of the housing 10 is formed on the outer side of the bottom wall of the rear housing part 10b, and the installation plate 150 of the locking member 15 is installed in the installation slot 15a.

As shown in FIG. 5, in the illustrated embodiment, the rear housing part 10b has a pair of opposite side walls in the transverse direction X, and engagement slots 15b are respectively formed on the outer sides of the pair of side walls of the rear housing part 10b. The locking member 15 also includes a pair of locking pieces 151, which are connected to both ends of the installation plate 150. The locking piece 151 and the engagement slot 15b are T-shaped and engaged with each other to fix the locking piece 15 to the housing 10.

As shown in FIGS. 1 to 4, in the illustrated embodiment, an elastic locking buckle 14 with a snap slot 14a is formed on the top wall of the housing 10. The snap slot 14a of the elastic locking buckle 14 is suitable for engaging with the protrusion 24a on the mating housing 20 of the mating connector 2 to lock the connector 1 and the mating connector 2.

As shown in FIG. 3, in the illustrated embodiment, the elastic locking buckle 14 includes a cantilever 141 and a support rib 142. The cantilever 141 has front and rear parts that are opposite in the longitudinal direction Y of the housing 10. The support rib 142 is connected between the middle of the cantilever 141 and the top wall of the housing 10. The cantilever 141 is suspended by the supporting rib 142 on the top wall of the housing 10, and the snap slot 14a is formed on the front part of the cantilever 141. The rear part of the cantilever 141 acts as an unlocking part, the elastic locking buckle 14 can be moved from a locking position engaged with the protrusion 24a to an unlocking position separated from the protrusion 24a by pressing the rear part of the cantilever 141.

As shown in FIGS. 1 to 9, in the illustrated embodiment, the connector 1 includes a pair of flexible circuit boards 11 spaced opposite each other in the height direction Z of the housing 10 and a single sealing element 12. A pair of slits 120 are formed in the single sealing element 12 to allow the pair of flexible circuit boards 11 to pass through, and the single sealing element 12 is fitted onto the pair of flexible circuit boards 11, so that the pair of flexible circuit boards 11 and the single sealing element 12 are assembled together.

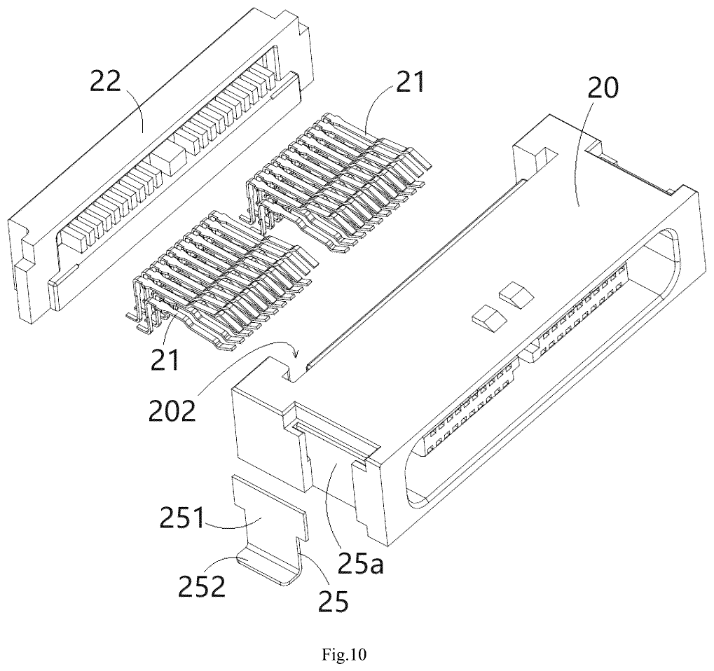

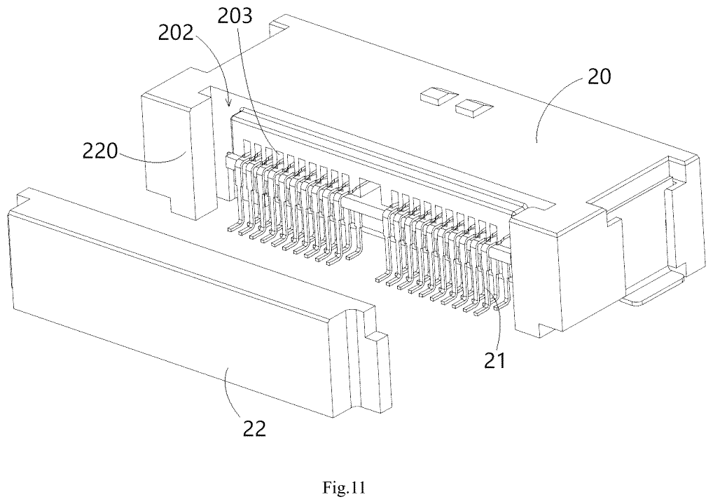

FIGS. 10 and 11 show a mating connector 2 according to an embodiment, which is part of a connector assembly that includes the connector 1 and the mating connector 2 matable with the connector 1.

As shown in FIGS. 2-4, 10, and 11, in the illustrated embodiment, the mating connector 2 includes a mating housing 20 and terminals 21. The mating housing 20 is formed with a receiving cavity 201 and a tongue portion 20a located in the receiving cavity 201. The terminal 21 is provided in the mating housing 20 and has a contact portion 21a located on the tongue portion 20a. The front housing part 10a of connector 1 is inserted into the receiving cavity 201 of the mating housing 20, the tongue portion 20a is inserted into the front housing part 10a, and the contact portion 21a of terminal 21 is in electrical contact with the gold finger 11a of the flexible circuit board 11.

As shown in FIG. 11, in the illustrated embodiment, the mating housing 20 has a front end wall 220 and a rear port that are opposite in its longitudinal direction Y. The front housing part 10a of the connector 1 is inserted into the rear port of the mating housing 20, and the terminal 21 extends out of the front end wall 220 of the mating housing 20.

As shown in FIG. 11, in the illustrated embodiment, a terminal slot 203 is formed in the front end wall 220 of the mating housing 20 to allow the terminal 21 to extend out, and a potting chamber 202 is formed on the outer side of the front end wall 220 to communicate with the terminal slot 203. The mating connector 2 also includes a potting seal 22 formed by the sealing glue poured into the sealing chamber 202 and the terminal slot 203, which is used to achieve sealing between the terminal 21 and the mating housing 20.

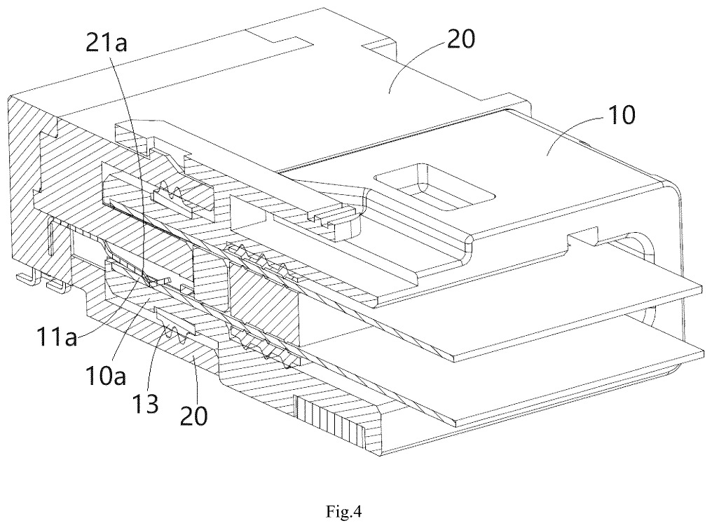

As shown in FIGS. 3 and 4, in the illustrated embodiment, the mating connector 2 includes two rows of terminals 21 spaced opposite each other in the height direction Z, which are used to make electrical contact with the two flexible circuit boards 11 in the connector 1. The terminal 21 has a soldering portion 21b exposed from the bottom of the mating housing 20 for soldering to a circuit board.

As shown in FIGS. 1 to 3, in the illustrated embodiment, a protrusion 24a is formed on the top wall of the mating housing 20, which is used to engage with the snap slot 14a on the elastic locking buckle 14 of the connector 1 to lock the connector 1 and the mating connector 2 in the mating state.

In the illustrated embodiment, the mating housing 20 has a pair of opposite side walls in its transverse direction X. The mating connector 2 also includes a pair of welding pieces 25, shown in FIGS. 2 and 10, which are respectively installed on the outer side of the pair of side walls of the mating housing 20 and are suitable for welding to the circuit board, for fixing the mating connector 2 to the circuit board.

As shown in FIG. 10, in the illustrated embodiment, a T-shaped locking slot 25a is formed on the outer side of the side wall of the mating housing 20. The welding piece 25 has a locking part 251 that locks into the locking slot 25a and a welding part 252 that is connected to the locking part 251 and suitable for welding to the circuit board.

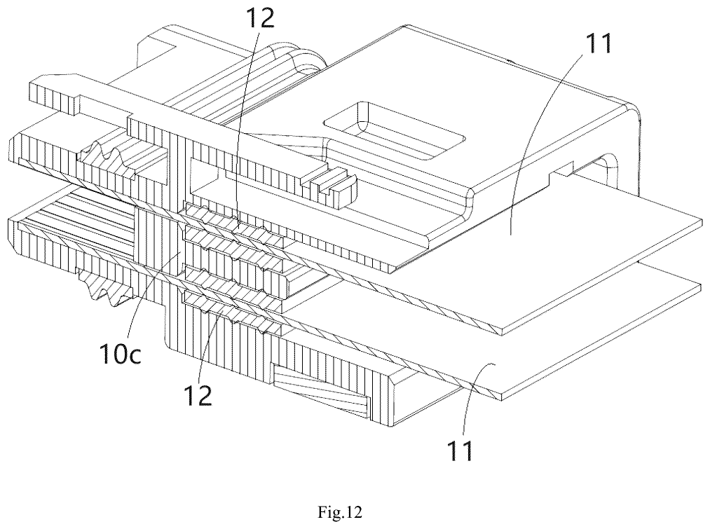

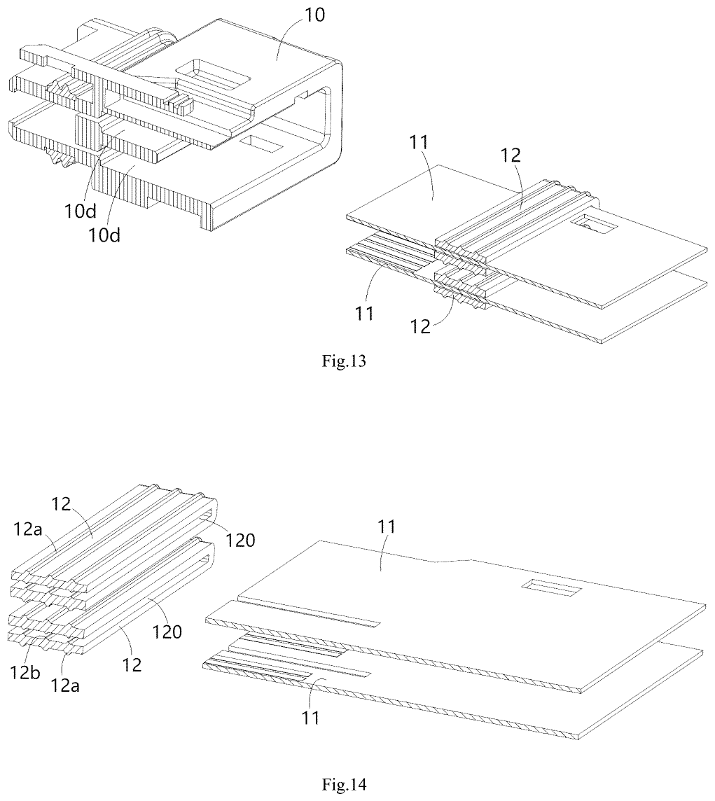

The main difference between the connector 1 shown in FIGS. 12 to 14 and the connector 1 shown in FIGS. 1 to 11 is the number of sealing elements 12. In the connector 1 shown in FIGS. 1 to 11, the connector 1 includes a single sealing element 12, while in the connector 1 shown in FIGS. 12 to 14, the connector 1 includes a pair of sealing elements 12.

As shown in FIGS. 12 and 14, in the illustrated embodiment, the connector 1 comprises a pair of flexible circuit boards 11 spaced opposite each other in the height direction Z of the housing 10 and a pair of sealing elements 12. A slit 120 is formed in each scaling element 12 to allow the flexible circuit board 11 to pass through, and the pair of sealing elements 12 are respectively fitted onto the pair of flexible circuit boards 11.

As shown in FIG. 12, in the illustrated embodiment, a partition wall 10c connected to the peripheral wall of the housing 10 is formed in the housing 10, and a pair of insertion slots 10d are formed in the partition wall 10c. The pair of flexible circuit boards 11 pass through the partition wall 10c through the pair of insertion slots 10d, and the pair of sealing elements 12 are respectively inserted into the pair of insertion slots 10d for sealing the pair of insertion slots 10d.

Except for the aforementioned differences, the other technical features of connector 1 shown in FIGS. 12 to 14 are the same as those of connector 1 shown in FIGS. 1 to 11. For the sake of simplicity, they will not be repeated here, and reference can be made to connector 1 shown in FIGS. 1 to 11.

In the aforementioned exemplary embodiments according to the present invention, the scaling between the flexible circuit board 11 and the housing 10 of the connector 1 can be reliably achieved by the sealing element 12 fitted on the flexible circuit board 11, so that the connector 1 can meet the waterproof requirements of IP67 or IP68.

In the aforementioned exemplary embodiments according to the present invention, the sealing glue poured into the potting chamber 202 and terminal slot 203 of the mating housing 20 can reliably achieve sealing between the terminal 21 of the mating connector 2 and the mating housing 20, enabling the mating connector 2 to meet the waterproof requirements of IP67 or IP68.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and preceded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
a housing having an inner cavity;
a flexible circuit board inserted into the inner cavity of the housing; and
a sealing element fitted on the flexible circuit board, the sealing element is inserted into the housing and compressed between the housing and the flexible circuit board to seal between the housing and the flexible circuit board.

2. The connector according to claim 1, wherein a slit is formed in the sealing element, the flexible circuit board passes through the slit, an annular outer sealing rib is formed on an outer peripheral surface of the sealing element, the annular outer sealing rib contacts an inner wall surface of the housing to seal between the sealing element and the housing, an annular inner sealing rib is formed on an inner peripheral surface of the sealing element, the annular inner sealing rib contacts an outer surface of the flexible circuit board to seal between the sealing element and the flexible circuit board.

3. The connector according to claim 1, wherein the housing has a front housing part and a rear housing part opposite each other in a longitudinal direction, the flexible circuit board has a gold finger on a front end portion, which is located in the front housing part for electrical contact with a terminal of a mating connector inserted into the front housing part, the sealing element is located in the rear housing part to prevent water vapor and dust from entering the front housing part from the rear housing part.

4. The connector according to claim 3, wherein the inner cavity of the housing has a front port and a rear port that are opposite in the longitudinal direction, the flexible circuit board and the sealing element are inserted into the housing from the rear port, the gold finger makes electrical contact with a terminal of the mating connector inserted into the front port.

5. The connector according to claim 3, further comprising a sealing ring fitted onto the front housing part, the front housing part is insertable into a mating housing of the mating connector, the sealing ring is compressed between the front housing part and the mating housing to achieve sealing between the front housing part and the mating housing.

6. The connector according to claim 3, further comprising a locking member installed on the rear housing part and locking the flexible circuit board in the housing.

7. The connector according to claim 6, wherein the locking member includes an installation plate installed on an outer side of the rear housing part and a locking tongue connected to the installation plate, an insertion hole is formed in a bottom wall of the rear housing part, and a slot hole corresponding to the insertion hole is formed in the flexible circuit board, the locking tongue passes through the insertion hole and the slot hole along a height direction of the housing to lock the flexible circuit board.

8. The connector according to claim 7, wherein a slot is formed on an inner side of a top wall of the rear housing part, and an end of the locking tongue is engaged into the slot.

9. The connector according to claim 7, wherein an installation slot extending along a transverse direction of the housing is formed on the outer side of the bottom wall of the rear housing part, the installation plate of the locking member is installed in the installation slot.

10. The connector according to claim 9, wherein the rear housing part has a pair of opposite side walls in the transverse direction, and a pair of engagement slots are respectively formed on a pair of outer sides of the pair of side walls of the rear housing part.

11. The connector according to claim 10, wherein the locking member includes a pair of locking pieces respectively connected to a pair of ends of the installation plate, each of the locking pieces and each of the engagement slots are T-shaped and engaged with each other to fix the locking pieces to the housing.

12. The connector according to claim 1, wherein a top wall of the housing has an elastic locking buckle with a snap slot, the snap slot of the elastic locking buckle engages with a protrusion on a mating housing of a mating connector to lock the connector and the mating connector.

13. The connector according to claim 12, wherein the elastic locking buckle includes:
a cantilever having a front part and a rear part opposite in a longitudinal direction of the housing; and
a support rib connected between a middle of the cantilever and the top wall of the housing, the cantilever is suspended on the top wall of the housing by the support rib, the snap slot is formed on the front part of the cantilever, the rear part of the cantilever acts as an unlocking part, the elastic locking buckle can be moved from a locking position engaged with the protrusion to an unlocking position separated from the protrusion by pressing the rear part of the cantilever.

14. The connector according to claim 1, wherein the flexible circuit board is one of a pair of flexible circuit boards spaced opposite each other in a height direction of the housing, the sealing element is fitted onto the pair of flexible circuit boards.

15. The connector according to claim 1, wherein the flexible circuit board is one of a pair of flexible circuit boards spaced opposite each other in a height direction of the housing, the sealing element is one of a pair of sealing elements that are each fitted on one of the pair of flexible circuit boards.

16. The connector according to claim 15, wherein a partition wall connected to a peripheral wall of the housing is formed in the housing, and a pair of insertion slots are formed in the partition wall, the pair of flexible circuit boards each pass through one of the pair of insertion slots, the pair of sealing elements are each positioned in one of the pair of insertion slots and seal one of the pair of insertion slots.

17. A connector assembly, comprising:
a connector including a housing having an inner cavity, a flexible circuit board inserted into the inner cavity of the housing, and a sealing element fitted on the flexible circuit board, the sealing element is inserted into the housing and compressed between the housing and the flexible circuit board to seal between the housing and the flexible circuit board; and
a mating connector mated with the connector.

18. The connector assembly according to claim 17, wherein the mating connector includes:
a mating housing having a receiving cavity and a tongue portion located in the receiving cavity; and
a terminal disposed in the mating housing and having a contact portion located on the tongue portion, a front housing part of the connector is inserted into the receiving cavity of the mating housing, the tongue portion is inserted into the front housing part, and the contact portion of the terminal is in electrical contact with the flexible circuit board.

19. The connector assembly according to claim 18, wherein the mating housing has a front end wall and a rear port that are opposite in a longitudinal direction, the front housing part of the connector is inserted into the rear port of the mating housing, a terminal slot allowing the terminal to extend out is formed in the front end wall of the mating housing, and a potting chamber communicated with the terminal slot is formed on an outer side of the front end wall, the mating connector has a potting seal formed by a sealing glue poured into the potting chamber and the terminal slot, the potting seal seals between the terminal and the mating housing.

20. The connector assembly according to claim 19, wherein the mating connector includes a pair of rows of terminals spaced opposite each other in a height direction, the flexible circuit board is one of a pair of flexible circuit boards of the connector, the rows of terminals each electrically contact one of the flexible circuit boards, the terminal has a soldering portion exposed from a bottom of the mating housing.
